(19) United States
(12) Patent Application Publication
(10) Pub. No.: US 2010/0040937 A1
(43) Pub. Date: Feb. 18, 2010

(54) SOLID FUEL COMPOSITION FOR A DIRECT LIQUID FUEL CELL

(75) Inventors: Gennadi FINKELSHTAIN, Lod (IL); Yuri Katsman, Hadera (IL); Leonid Sklyarski, Rehovot (IL); Alexander Shirokov, Ashkelon (IL)

Correspondence Address: GREENBLUM & BERNSTEIN, P.L.C., 1950 ROLAND CLARKE PLACE, RESTON, VA, 20191, US

(73) Assignee: MORE ENERGY Ltd. of Lod, Israel

(21) Appl. No.: 12/333,747

(22) Filed: Dec. 12, 2008

Related U.S. Application Data
(60) Provisional application No. 61/055,677, filed on May 23, 2008.

(51) Int. Cl. H01M 8/02

(52) U.S. Cl. 429/46

(57) ABSTRACT

A solid fuel composition which is suitable for preparing a liquid fuel for a direct liquid fuel cell. The composition comprises at least one solid hydride compound selected from borohydrides, aluminum hydrides, and metal hydrides, and at least one alkaline compound selected from hydroxides of alkali and alkaline earth metals, Zn, Al, and ammonium. If placed in a direct liquid fuel cell and contacted with an aqueous liquid the composition dissolves gradually as the at least one hydride compound is consumed while the fuel cell is in operation. This Abstract is neither intended to define the invention disclosed in this specification nor intended to limit the scope of the invention in any way.

### CROSS-REFERENCE TO RELATED APPLICATIONS

The present application claims priority under 35 U.S.C. §119(e) of U.S. provisional application No. 61/055,677, filed May 23, 2008, the entire disclosure whereof is expressly incorporated by reference herein.

### BACKGROUND OF THE INVENTION

1. Field of the Invention

The present invention relates generally to hydride-containing solid compositions which are suitable for preparing liquid fuels for direct liquid fuel cells.

2. Discussion of Background Information

Fuel cells are electrochemical power sources wherein an electrocatalytic oxidation of a fuel (e.g., molecular hydrogen or methanol) at an anode and an electrocatalytic reduction of an oxidant (frequently molecular oxygen) at a cathode take place simultaneously. Conventional fuels such as hydrogen and methanol pose several storage and transportation problems, in particular, for portable fuel cells (e.g., for use with portable electric and electronic devices such as laptops, cell phones, and the like).

Borohydride (and other hydride) based fuels are of particular interest for portable fuel cells, due to their very high specific energy capacity (see, e.g., J. of Electrochem. Soc., 150, (3), A398-402, 2003). This type of fuels may be used either directly as the fuel or indirectly as a generator of hydrogen (which is oxidized at the anode), e.g., as part of a portable proton exchange membrane (PEM) fuel cell (see, e.g., US 20010045364 A1, US 20030207160 A1, US 20030207157 A1, US 20030099876 A1, and U.S. Pat. Nos. 6,554,877 B2 and 6,562,497 B2). The disclosures of all of the above documents are expressly incorporated by reference herein in their entireties.

In contact with neutral or slightly acidic aqueous media borohydride compounds undergo a slow hydrolysis reaction with generation of hydrogen gas according to the following equation:

BH₄⁻+2H₂O=BO₂⁻+4H₂.

If a generation of hydrogen gas by hydrolysis of a borohydride is desired, the above reaction can be accelerated by heterogeneous catalysts (with catalysts such as, e.g., Pt, Pd, Co, and Ni) or by a homogeneous catalysis (e.g., by contacting the borohydride with an acidic solution). In this regard see, for example, U.S. Pat. No. 6,818,334 B2, US 2002/0083643 A1 and US 2006/0196112 A1, the entire disclosures whereof are incorporated by reference herein.

In order to prevent or at least slow down the above hydrolysis reaction and to improve in particular, the long-term stability of (liquid or semi-liquid) borohydride compositions (which is important for storage and/or transport, even if the composition ultimately is to be used for the generation of hydrogen gas) borohydride containing compositions usually contain one or more compounds which provide a strongly basic environment. These compounds are typically hydroxides of alkali and alkaline earth metals, Zn, Al and ammonium.

The main oxidation reaction of a borohydride based fuel at the anode of a direct liquid fuel cell can be represented as follows:

BH₄⁻+8OH⁻=BO₂⁻+6H₂O+8e⁻.

There are several factors which have to be taken into account when assessing the performance of a hydride based fuel. One of these factors is the efficiency of the fuel. Fuel efficiency can be determined, for example, by comparing the actual energy density (Wh/volume unit fuel) provided in a given fuel cell to the theoretical energy density. The absolute value of the energy density is also one of the indicators of fuel performance. In this regard, it is to be taken into account that while a high (boro)hydride concentration in the fuel may afford a desired high energy density of the fuel, in some situations a high concentration of (boro)hydride (and/or basic compound) in the liquid phase of the fuel may also be disadvantageous.

Typical technical problems which are encountered with liquid fuels (solutions or suspensions) include fuel leakage during transport, storage, operation and/or utilization of the fuel and low reliability and efficiency of different parts of the fuel cell which come into contact with the liquid fuel (for example, anode, gas elimination device, valves, etc.) as result of solid particle influence and/or corrosive action of the liquid fuel (also due, at least in part to the presence of a strongly basic stabilizing compound for the hydride). Further, when solids precipitate from an oversaturated fuel solution (high concentration of active components) this may cause problems with respect to the porous elements of the fuel cell (anodes, membranes) due to clogging of pores. Further, in the case of fuel concentrates in the form of a paste it sometimes is difficult to “pump” or transport the paste, especially in the case of a highly concentrated and thus, highly viscous paste. Accordingly, in order to improve the “pumpability” of the paste, the concentration of the solid components has to be decreased, which is undesirable.

Accordingly, one usually has to find a compromise between energy density of the fuel and transportability and compatibility of the fuel with the components of the fuel cell and/or find ways to avoid significant damage to the fuel cell components despite a relatively high concentration of (boro)hydride in the fuel. It would also be advantageous to be able to have a high alkalinity of the fuel during storage (stabilization) but a low alkalinity during usage (to increase the discharge energy provided by the liquid fuel).

It has now been found that the above problems can be avoided or at least ameliorated by providing the hydride-based fuel for a direct liquid fuel cell not as a liquid (e.g., a high viscosity liquid such as a paste) but in the form of a preferably compacted solid composition which comprises at least a hydride compound and optionally, also a basic compound and which, when contacted with an aqueous liquid which is capable of dissolving the mixture, releases the components thereof not spontaneously but slowly and gradually and depending on the consumption of the hydride compound at the anode of the direct liquid fuel cell.

### SUMMARY OF THE INVENTION

The present invention provides a (preferably compacted) solid fuel composition which is suitable for preparing a liquid fuel for a direct liquid fuel cell. The composition comprises, based on the total weight of the composition, from about 10% to about 99.8% by weight of (i) at least one hydride compound which is selected from borohydrides, aluminum hydrides, and metal hydrides, and from about 0.1% to about 50% by weight (ii) of at least one alkaline compound selected from hydroxides of alkali and alkaline earth metals, Zn, Al, and ammonium. When placed in a direct liquid fuel cell and contacted with an aqueous liquid which is capable of dissolving the composition (e.g., an aqueous liquid which comprises at least about 50% by volume of water), the composition dissolves gradually (i.e., not substantially immediately) as the at least one hydride compound is consumed at the anode of the fuel cell while the fuel cell is in operation.

In one aspect, the solid fuel composition of the present invention may provide a discharge energy and/or an operating power in the direct liquid fuel cell which is at least about 10% (e.g., at least about 20%, at least about 25%, or at least about 30%) higher than the discharge energy and/or the operating power that is provided by a liquid fuel (e.g., a solution and/or suspension) of the same composition (i.e., the amounts of all solid and liquid components are identical) under identical conditions.

In another aspect, the solid fuel composition may comprise from about 20% to about 60% by weight, e.g., from about 40% to about 50% by weight of (i) and/or (i) may comprise one or more of LiBH₄, NaBH₄, KBH₄, NH₄BH₄, Be(BH₄)₂, Mg(BH₄)₂, Ca(BH₄)₂, Zn(BH₄)₂, Al(BH₄)₃, a polyborohydride, (CH₃)₂NHBH₃, NaCNBH₃, Li(AlH₄), LiH, NaH, KH, MgH₂, and CaH₂ and/or (i) may have an average particle size (determined, e.g., by sieve analysis) of from about 0.005 mm to about 3 mm, e.g., an average particle size of from about 0.01 mm to about 1 mm, or an average particle size of from about 0.02 mm to about 0.1 mm.

In yet another aspect, the solid fuel composition of the present invention may comprise from about 1% to about 20% by weight, e.g., from about 5% to about 10% by weight of (ii) and/or (ii) may comprise one or more of LiOH, NaOH, KOH, NH₄OH, Mg(OH)₂, Ca(OH)₂, Ba(OH)₂, Zn(OH)₂, and Al(OH)₃ and/or (ii) may have an average particle size (determined, e.g., by sieve analysis) of from about 0.05 mm to about 10 mm, e.g., an average particle size of from about 0.5 mm to about 7 mm, or an average particle size of from about 2 mm to about 4 mm.

In a still further aspect, the solid fuel composition or at least a part thereof may have been compacted, for example, by compressing it under a pressure of from about 1 kg/cm² to about 100,000 kg/cm², e.g., under a pressure of from about 50 kg/cm² to about 2,000 kg/cm², or under a pressure of from about 200 kg/cm² to about 1,000 kg/cm².

In another aspect, the solid fuel composition of the present invention may further comprise up to about 20% by weight of water, e.g., from about 1% to about 10% by weight of water, or from about 2% to about 5% by weight of water, based on the total weight of the solid composition.

In another aspect, the solid fuel composition of the present invention may further comprise at least one binder. For example, the at least one binder may be present in a concentration of up to 20% by weight, e.g., in a concentration of from about 1% to about 10% by weight, or in a concentration of from about 2% to about 5% by weight, based on the total weight of the solid composition.

In yet another aspect, the solid fuel composition of the present invention may be present as a tablet, a pellet, a flake and/or a granule.

In another aspect, components (i) and (ii) of the solid fuel composition of the present invention may be present as a physical (preferably intimate) mixture, or components (i) and (ii) may be present in physically separated form (e.g., in the form of layers of a tablet), or both.

The present invention also provides a solid fuel composition which is suitable for preparing a liquid fuel for a direct liquid fuel cell and is obtainable by compacting a solid mixture which comprises, based on the total weight of the mixture, from about 10% to about 99.8% by weight of (i) at least one hydride compound selected from borohydrides, aluminum hydrides, and metal hydrides, and from about 0.1% to about 50% by weight of (ii) at least one alkaline compound selected from hydroxides of alkali and alkaline earth metals, Zn, Al, and ammonium. Component (i) has an average particle size (determined, e.g., by sieve analysis) of from about 0.005 mm to about 3 mm and component (ii) has an average particle size (determined, e.g., by sieve analysis) of from about 0.05 mm to about 10 mm.

In one aspect, the mixture may comprise from about 20% to about 60% by weight of (i) and/or (i) may comprise one or more of LiBH₄, NaBH₄, KBH₄, NH₄BH₄, Be(BH₄)₂, Mg(BH₄)₂, Ca(BH₄)₂, Zn(BH₄)₂, Al(BH₄)₃, a polyborohydride, (CH₃)₂NHBH₃, NaCNBH₃, Li(AlH₄), LiH, NaH, KH, MgH₂, and CaH₂ and/or (i) may have an average particle size of from about 0.01 mm to about 1 mm.

In another aspect, the mixture may comprise from about 1% to about 20% by weight of (ii) and/or (ii) may comprise one or more of LiOH, NaOH, KOH, NH₄OH, Mg(OH)₂, Ca(OH)₂, Ba(OH)₂, Zn(OH)₂, and Al(OH)₃ and/or (ii) may have an average particle size of from about 0.5 mm to about 7 mm.

In another aspect, the mixture may have been obtained by compressing it under a pressure of from about 50 kg/cm² to about 2,000 kg/cm².

The present invention also provides a method of making a solid fuel composition which is suitable for preparing a liquid fuel for a hydride-based direct liquid fuel cell. The method comprises compacting under a pressure of from about 1 kg/cm² to about 100,000 kg/cm² an intimate mixture which comprises, based on the total weight of the mixture, from about 10% to about 99.8% by weight of (i) at least one hydride compound selected from borohydrides, aluminum hydrides, and metal hydrides, and from about 0.1% to about 50% by weight of (ii) at least one alkaline compound selected from hydroxides of alkali and alkaline earth metals, Zn, Al, and ammonium. Component (i) has an average particle size (determined, e.g., by sieve analysis) of from about 0.005 mm to about 3 mm and component (ii) has an average particle size (determined, e.g., by sieve analysis) of from about 0.05 mm to about 10 mm.

In one aspect of the method, the mixture may comprise from about 20% to about 60% by weight of (i) and from about 1% to about 20% by weight of (ii) and/or the compaction pressure may be from about 50 kg/cm² to about 2,000 kg/cm².

In another aspect, (i) may have an average particle size of from about 0.01 mm to about 1 mm and/or (ii) may have an average particle size of from about 0.5 mm to about 7 mm.

The present invention also provides a method of providing a hydride-based direct liquid fuel cell with liquid fuel. The method comprises providing in the fuel chamber of the fuel cell and/or a cartridge which is connectable to or connected with the fuel cell at least one solid hydride compound selected from borohydrides, aluminum hydrides, and metal hydrides in combination with (a) at least one solid alkaline compound selected from hydroxides of alkali and alkaline earth metals, Zn, Al, and ammonium and an aqueous liquid which is capable of dissolving the at least one solid hydride compound and the at least one solid alkaline compound (e.g., an aqueous liquid which comprises at least about 50% by volume of water, based on the total volume of the liquid) and/or (b) an alkaline aqueous liquid which is capable of dissolving the at least one solid hydride compound. The at least one solid hydride compound dissolves gradually as it is consumed (oxidized) at the anode of the fuel cell while the fuel cell is in operation.

The present invention also provides a method of increasing the discharge energy and/or the operating power provided by a hydride-containing fuel for a direct liquid fuel cell. The method comprises providing the fuel as a combination of at least one solid hydride compound selected from borohydrides, aluminum hydrides, and metal hydrides with (a) at least one solid alkaline compound selected from hydroxides of alkali and alkaline earth metals, Zn, Al, and ammonium and an aqueous liquid which is capable of dissolving the at least one solid hydride compound and the at least one solid alkaline compound and/or (b) an alkaline aqueous liquid which is capable of dissolving the at least one solid hydride compound. The at least one solid hydride compound dissolves gradually in the aqueous liquid as it is consumed at the anode of the fuel cell while the fuel cell is in operation.

In one aspect of the method, the fuel may provide a discharge energy and/or an operating power in a direct liquid fuel cell which is at least about 10% higher (e.g., at least about 20% higher or at least about 25% higher) than the discharge energy and/or operating power that is provided by a dissolved and/or suspended solid mixture of the same composition (i.e., the concentrations of all solid and liquid components are identical) under identical conditions.

The present invention also provides a hydride-based direct liquid fuel cell which comprises a solid fuel composition of the present invention as set forth above (including the various aspects thereof).

The present invention also provides a hydride-based direct liquid fuel cell wherein the main body of the fuel cell and/or a part or device connected to or connectable therewith comprises at least one solid hydride compound selected from borohydrides, aluminum hydrides, and metal hydrides.

In one aspect of the fuel cell, the at least one solid hydride compound may be present in combination with at least one of (a) at least one solid alkaline compound selected from hydroxides of alkali and alkaline earth metals, Zn, Al, and ammonium, and (b) an alkaline aqueous liquid which is capable of dissolving the at least one solid hydride compound.

In another aspect, at least the fuel chamber of the fuel cell may comprise the at least one solid hydride compound and/or at least a cartridge which is connectable with or connected to the fuel cell may comprise at least a part of the at least one solid hydride compound. For example, the cartridge may be an integral part of the fuel cell.

In another aspect of the fuel cell, the main body of the fuel cell and/or the part or device may comprise an aqueous liquid which is capable of dissolving the solid hydride compound.

In yet another aspect, the fuel cell may be portable and/or suitable (designed) for charging a portable electric or electronic device (e.g., a cell phone, a laptop computer, etc.).

The present invention also provides a solid hydride-containing body which is suitable for preparing a liquid fuel for a direct liquid fuel cell. The body comprises at least one solid hydride compound selected from borohydrides, aluminum hydrides, and metal hydrides and, if placed in a direct liquid fuel cell and contacted with an aqueous liquid which is capable of dissolving the body, dissolves gradually as the at least one hydride compound is consumed while the fuel cell is in operation and/or the body is obtainable by compacting a solid composition which comprises at least one solid hydride compound which is selected from borohydrides, aluminum hydrides, and metal hydrides and has an average particle size of from about 0.005 mm to about 3 mm.

In one aspect of the body of the present invention, the body may further comprise (i) at least one solid alkaline compound selected from hydroxides of alkali and alkaline earth metals, Zn, Al, and ammonium, and/or (ii) up to about 20% by weight of water and/or (iii) at least one binder. The at least one binder may, for example, be present in a concentration of up to 20% by weight, e.g., up to about 10% or up to about 5% by weight, based on the total weight of the body.

In another aspect of the body, the body may be present in the form of a tablet, a pellet, a flake or a granule and/or may comprise at least two parts. For example, the body may be present as a tablet, e.g., a tablet having at least two parts or layers (e.g., a bi-layered tablet or a multi-layered tablet).

In one aspect, at least one part of the at least two parts (e.g., layers) of the body (e.g., tablet) may comprise at least about 70% by weight (e.g., at least about 80%, at least about 90%, at least about 95% or at least about 98% by weight) of the at least one hydride compound, based on the total weight of the part and/or at least one of the at least two parts may comprise at least about 70% by weight (e.g., at least about 80%, at least about 90%, at least about 95% or at least about 98% by weight) of at least one alkaline compound, based on the total weight of the part.

In another aspect of the body, the body may comprise at least a first part which comprises at least about 70% by weight (e.g., at least about 80%, at least about 90%, at least about 95% or at least about 98% by weight) of at least one first hydride compound, based on the total weight of the first part, and a second part which comprises at least about 70% by weight (e.g., at least about 80%, at least about 90%, at least about 95% or at least about 98% by weight) of at least one second hydride compound which is different from the at least one first hydride compound, based on the total weight of the second part.

In yet another aspect, the body may comprise a core and at least one layer or coating which surrounds the core at least partially (e.g. substantially completely). For example, the core may comprise at least about 70% by weight (e.g., at least about 80%, at least about 90%, at least about 95% or at least about 98% by weight) of at least one first hydride compound, based on the total weight of the core, and the at least one layer or coating may comprise at least about 70% by weight (e.g., at least about 80%, at least about 90%, at least about 95% or at least about 98% by weight) of at least one second hydride compound which is different from the at least one first hydride compound, based on the total weight of the at least one layer or coating. Also by way of non-limiting example, the solubility in water of the at least one second hydride compound (e.g., KBH₄) may be higher than the solubility in water of the at least one first hydride compound (e.g., NaBH₄).

In a still further aspect, the body may comprise a water-soluble matrix which has particles of the at least one solid hydride compound dispersed therein. In another aspect, the body may further comprise particles of at least one alkaline compound selected from hydroxides of alkali and alkaline earth metals, Zn, Al, and ammonium which are dispersed in the matrix.

### BRIEF DESCRIPTION OF THE DRAWINGS

The present invention is further described in the detailed description which follows, in reference to the noted plurality of drawings by way of non-limiting examples of exemplary embodiments of the present invention, wherein:

FIG. 1 shows a discharge curve of a direct borohydride—air fuel cell comprising the fuel described in Example 1;

FIG. 2 shows a discharge curve of a direct borohydride—air fuel cell comprising the fuel described in Example 2.

FIG. 3 shows a discharge curve of a direct borohydride—air fuel cell comprising the fuel described in Example 3.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those skilled in the art how the several forms of the present invention may be embodied in practice.

The hydride compounds which are suitable for use in the present invention are compounds which are capable of being oxidized as such at the anode of a fuel cell to provide electrons, i.e., compounds which are capable of being oxidized at the anode without intermediate generation of hydrogen gas, although generation of hydrogen gas and oxidation of the hydrogen gas may possibly take place as side reactions at the anode. Hydride compounds for use in the present invention include “simple” metal hydrides, complex hydrides such as borohydrides, including cyanoborohydrides and polyborohydrides, and aluminum hydrides of alkali metals such as, e.g., Li, Na, K, Rb and Cs, and alkaline earth metals such as, e.g., Be, Mg, Ca, Sr and Ba, but also of other metals such as Al and Zn, and ammonium. Non-limiting specific examples of suitable hydride compounds include LiBH₄, NaBH₄, KBH₄, NH₄BH₄, Be(BH₄)₂, Ca(BH₄)₂, Mg(BH₄)₂, (CH₃)₃NHBH₃, NaCNBH₃, LiH, NaH, KH, CaH₂, BeH₂, MgH₂, NaAlH₄, LiAlH₄ and KAlH₄. Polyborohydrides may be used as well. Non-limiting examples of polyborohydrides are those of formulae MB₃H₈, M₂B₁₀H₁₀, MB₁₀H₁₃, M₂B₁₂H₁₂ and M₂B₂₀H₁₈ wherein M may be Li, Na, K, NH₄, Be_{1/2}, Ca_{1/2}, Mg_{1/2}, Zn_{1/2} or Al_{1/3} (the fractions associated with Ca, Mg, Zn and Al take into account that these metals are bi- or trivalent). Further examples of polyborohydride compounds which are suitable for use in the present invention are disclosed in, e.g., US 2005/0132640 A1, the entire disclosure whereof is incorporated by reference herein. Borohydrides and, in particular, alkali metal borohydrides such as NaBH₄ and KBH₄ are examples of preferred hydrides for the purposes of the present invention.

In this regard, it is noted that it may be advantageous to use at least two hydride compounds in the solid fuel composition or the solid hydride-containing body of the present invention. Mixtures of two borohydride compounds such as, e.g., NaBH₄ and KBH₄ are preferred. If two hydride compounds are employed in combination, the molar ratio of the first hydride compound and the second hydride compound may be from about 95:5 to about 5:95, e.g., from about 90:10 to about 10:90, from about 80:20 to about 20:80, from about 75:25 to about 25:75, or from about 60:40 to about 40:60. In this regard, reference may be made to US 2006/0213119 A1, the entire disclosure whereof is incorporated by reference herein. For example, in the case of the hydride-containing body of the present invention, two borohydride compounds such as, e.g., NaBH₄ and KBH₄ may be present in separate parts or layers of a tablet or a core which comprises, e.g., NaBH₄ may be surrounded by a coating or layer which comprises, e.g., KBH₄.

The solid fuel composition or body of the present invention will usually comprise at least about 10% by weight, e.g., at least about 20%, at least about 30%, or at least about 40% by weight of the one or more hydride compounds, based on the total weight of the composition or body. The concentration of the one or more hydride compounds in the composition or body may be up to about 100%, but will often be not higher than about 99.8% by weight, e.g., not higher than about 98%, not higher than about 95%, not higher than about 90%, not higher than about 80%, not higher than about 70%, not higher than about 60%, or not higher than about 50% by weight.

The average (initial) particle size of the one or more hydride compounds for making the solid fuel composition or body of the present invention (determined by, e.g., sieve analysis) will usually be not lower than about 0.005 mm, e.g., not lower than about 0.01 mm, not lower than about 0.02 mm, or not lower than about 0.05 mm, and will usually be not higher than about 3 mm, e.g., not higher than about 2 mm, not higher than about 1 mm, not higher than about 0.5 mm, or not higher than about 0.1 mm. If the particle size of a compound is higher than desired the particle size can be reduced, for example, by grinding. The particle size is one of the factors by which the dissolution rate and/or the dissolution behavior of the solid composition or body of the present invention can be controlled, with smaller particle sizes usually resulting in higher dissolution rates.

The at least one alkaline compound for use in a solid composition or body of the present invention is selected from alkali or alkaline earth metal hydroxides, the hydroxides of zinc and aluminum, and ammonium hydroxide. In this regard, it should be noted that the term “hydroxide” as used herein and in the appended claims also includes the corresponding oxides and hydrated oxides. Non-limiting specific examples of suitable alkaline compounds are LiOH, NaOH, KOH, Ca(OH)₂, Mg(OH)₂, Ba(OH)₂, Zn(OH)₂, Al(OH)₃ and NH₄OH. Often, NaOH and/or KOH will be employed.

In cases where the at least one alkaline compound is present in the solid composition or body of the present invention it will usually comprise at least about 0.1% by weight, e.g., at least about 1%, at least about 2%, or at least about 5% by weight of the one or more alkaline compounds, based on the total weight of the composition, or body. Usually the concentration of the one or more alkaline compounds in the composition or body will not be higher than about 50% by weight, e.g., not higher than about 40%, not higher than about 30%, not higher than about 20%, not higher than about 15%, or not higher than about 10% by weight.

The average (initial) particle size of the one or more alkaline compounds for use in the present invention (determined by, e.g., sieve analysis) will usually be not lower than about 0.05 mm, e.g., not lower than about 0.5 mm, not lower than about 1 mm, or not lower than about 2 mm, and will usually be not higher than about 10 mm, e.g., not higher than about 7 mm, not higher than about 6 mm, not higher than about 5 mm, or not higher than about 4 mm. If the particle size of a compound is higher than desired the particle size can be reduced, for example, by grinding. As set forth above, the particle size is one of the factors by which the dissolution rate and/or dissolution behavior can be controlled, with smaller particle sizes usually resulting in higher dissolution rates.

In addition to the one or more hydride compounds and optionally, the one or more alkaline compounds the solid fuel composition or body of the present invention may optionally contain various other components. Of course, if the composition or body is to be used for making a liquid fuel for a direct liquid fuel cell these components or additives must not adversely affect the operation of the fuel cell and in particular, must not interfere with the anodic oxidation of the hydride compound(s) to any significant extent.

For example, the solid fuel composition or body may comprise water, as such and/or in the form of a hydrate (e.g., a hydrate of a borohydride compound). Water can also act as a binder for the composition or body. If water is present, it will usually be present in an amount which is not higher about 20% by weight, e.g., not higher than about 10% by weight or not higher than about 5% by weight, based on the total weight of the solid fuel composition or body. If water is deliberately added (i.e., not only present as a result of, e.g., the hygroscopic nature of the one or more alkaline compounds) the water content will usually be at least about 0.1% by weight, e.g., at least about 1%, or at least about 2% by weight.

One or more binders may be present in the solid fuel composition or body of the present invention, for example, to improve the shape retention of a tablet or other shaped article. Usually, the use of a binder can be dispensed with. Examples of suitable binders are known to those of skill in the art and include organic binders such as, e.g., cellulose and derivatives thereof (e.g., microcrystalline cellulose, hydroxyalkyl celluloses, etc.), sugars (e.g., sucrose, lactose), glycerol, and polyalkylene glycols (e.g., polyethylene glycols, polypropylene glycols, and mixtures thereof), and inorganic binders such as, e.g., phosphates (e.g., dicalcium phosphate dehydrate), to name but a few. If one or more binders are present, the concentration thereof will usually be not higher than about 20%, e.g., not higher than about 10%, or not higher than about 5% by weight, based on the total weight of the solid composition or body. On the other hand, the binder(s), if present at all, will usually be present in a concentration which is not lower than about 1%, e.g., not lower than about 2% by weight. The average particle size of the one or more binders, if present, will usually be not higher than about 1 mm, e.g., not higher than about 0.5 mm, or not higher than about 0.1 mm, but usually not lower than about 0.001 mm, e.g., not lower than about 0.02 mm, or not lower than about 0.05 mm.

Another factor by which the dissolution rate and/or the dissolution behavior of the solid fuel composition of the present invention can be influenced (in addition to, e.g., the (initial) particle size of the hydride and alkaline compounds) is the compaction. In other words, the higher the compaction pressure the lower the dissolution rate will usually be. The solid fuel composition or body or parts thereof of the present invention will often be compressed, although compression is only one way of compacting and shaping same. In the case of compression the pressure will usually be at least about 1 kg/cm², e.g., at least about 50 kg/cm², at least about 100 kg/cm², at least about 200 kg/cm², or at least about 250 kg/cm², but will usually be not higher than about 100,000 kg/cm², e.g., not higher than about 10,000 kg/cm², not higher than about 2000 kg/cm², not higher than about 1000 kg/cm², or not higher than about 700 kg/cm². The temperature during pressing will often be in the range of from about 0° C. to about 500° C., e.g., from about 10° C. to about 100° C., or from about 20° C. to about 40° C. Pressing times will often be in the range of from about 1 to about 1,000 seconds, e.g., from about 2 to about 50 seconds, or from about 3 to about 10 seconds.

The preparation of a solid fuel composition of the present invention may involve several stages, for example: (a) grinding one or more of the components (if the particle size is to be reduced, particularly in the case of the alkaline compound(s)); (b) wetting the dry component(s) (for example, to correct the water content and ensure that each batch contains the same amount of water); (c) if two or more components are present, homogenizing the solid mixture; (d) pressing and/or rolling (to achieve the desired shape); (e) packaging and/or encapsulating (e.g., to protect the composition or body against wetting and carbonization during long term storage).

The solid fuel composition or body of the present invention may be present in various shapes and forms. For example, it may be in the form of granules, tablets (round, rectangular, cubes, etc.), pellets, flakes or any other form which is suitable and/or convenient for use in combination with a fuel cell and/or a fuel cartridge for the fuel cell.

Also, the solid fuel composition of the present invention or a component thereof may be rolled onto a (preferably hydrophilic) mesh or a (preferably hydrophilic) membrane or may be placed (sandwiched) between two meshes/membranes (e.g., in order to increase the strength of the structure). Further, the solid composition or one or more components thereof may be incorporated into a porous (preferably hydrophilic) matrix. In this case, the control of the dissolution rate by the applied pressure in the case of compression may be replaced by the control of the dissolution/diffusion rate by the pores (e.g., pore size) of the matrix. Non-limiting examples of materials for use in the matrix include polymers such as polyvinyl alcohol, cellulose and derivatives thereof (e.g., hydroxypropylmethylcellulose, methylcellulose, etc.), polyamides (e.g., nylons), salts and/or esters of polyacrylic and polymethacrylic acids, polyalkylene oxides (e.g., polyethylene oxides), and polyurethanes, and metals such as nickel and stainless steel. Of course, combinations of two or more materials can be used as well.

It further is possible to provide the solid composition or body of the present invention with a (preferably water-soluble) coating, for example, in order to improve the structural integrity of the shaped mixture and/or to protect the composition or body from environmental influences.

If a liquid fuel for a direct liquid fuel cell is to be prepared, the aqueous liquid used for (gradually) dissolving the solid fuel composition or body of the present invention will usually comprise water, either alone or in combination with one or more (preferably water-miscible and/or water-soluble) organic substances. Non-limiting examples of corresponding organic substances include (cyclo)aliphatic alcohols having up to about 6 carbon atoms and up to about 6 hydroxy groups, C₂₋₄ alkylene glycols, di(C₂₋₄ alkylene glycols), poly(C₂₋₄ alkylene glycols), mono-C₁₋₄-alkyl ethers of C₂₋₄ alkylene glycols, di(C₂₋₄ alkylene glycols) and poly(C₂₋₄ alkylene glycols), di-C₁₋₄-alkyl ethers of C₂₋₄ alkylene glycols, di(C₂₋₄ alkylene glycols) and poly(C₂₋₄ alkylene glycols), ethylene oxide/propylene oxide block copolymers, ethoxylated aliphatic polyols, propoxylated aliphatic polyols, ethoxylated and propoxylated aliphatic polyols, aliphatic ethers having up to about 6 carbon atoms, aliphatic ketones having up to about 6 carbon atoms, aliphatic aldehydes having up to about 6 carbon atoms, C₁₋₄-alkyl esters of C₁₋₄ alkanoic (aliphatic) acids and primary, secondary and tertiary aliphatic amines having a total of up to about 10 carbon atoms. By way of non-limiting example, the aqueous liquid may comprise water and one or more of methanol, ethanol, propanol, isopropanol, ethylene glycol, diethylene glycol, 1,2,4-butanetriol, trimethylolpropane, pentaerythritol, sorbitol (or any other sugar alcohol), glycerol, acetone, methyl ethyl ketone, diethyl ketone, methyl acetate, ethyl acetate, dioxan, tetrahydrofuran, diglyme, triglyme, monoethanolamine, diethanolamine, triethanolamine, monopropanolamine, dipropanolamine and tripropanolamine.

If water is used in combination with at least one organic solvent the concentration of water in the corresponding mixture will usually be at least about 50%, e.g., at least about 70%, at least about 80%, at least about 90%, or at least about 95% by volume, based on the total volume of the aqueous liquid. Of course, the aqueous liquid may contain other substances dissolved and/or suspended therein. Non-limiting examples of dissolved and/or suspended substances include one or more alkaline substances, preferably one or more alkaline substances which are also present in the solid composition (and optionally also the body) of the present invention (although the one or more alkaline substances may be different, at least in part, from the one or more alkaline substances which are present in the composition or body). If present, the concentration of the dissolved substance(s) will usually be low, e.g., not more than about 20%, not more than about 10%, not more than about 5%, or not more than about 2% by weight, based on the total weight of the aqueous liquid. Of course, it is also possible, although not preferred, for the aqueous liquid to comprise at least one hydride compound that is present in the solid composition or body.

The aqueous liquid and the solid fuel composition or body of the present invention may be combined in any ratios which result in a liquid fuel that is suitable for use in a direct liquid fuel cell. Under the assumption of a complete dissolution in the aqueous liquid (without consumption of the hydride compound at the anode of the fuel cell) the hydroxide ion concentration in the corresponding solution will often be at least about 0.01 mole per liter, e.g., at least about 0.05 mole per liter, at least about 0.1 mole per liter, at least about 0.5 mole per liter, at least about 1 mole per liter, at least about 1.5 moles per liter, at least about 2 moles per liter, or at least about 3 moles per liter, but preferably not higher than about 6 moles per liter, e.g., not higher than about 5 moles per liter.

The solid composition or body of the present invention may be used in any direct liquid fuel cell. Non-limiting examples of direct liquid fuel cells and advantageous embodiments and features thereof are described in, e.g., U.S. Pat. No. 7,004,207 and US 2005/0155668 A1, US 2005/0058882 A1, US 2005/0158609 A1, US 2005/0206342 A1, Ser. No. 10/824,443 US 2005/0233190 A1, US 2004/0241521 A1, US 2005/0260481 A1, US 2006/0047983 A1, US 2006/0078783 A1, US 2006/0057435 A1, US 2006/0057437 A1, US2002/0076602 A1, US2002/0142196 A1, US 2003/0099876 A1, US 2007/0154774 A1, US 2006/0147789 A1, US 2007/0298306 A1, US 2007/0212578 A1, US 2007/0218339 A1, and US 2008/0003468 A1, the entire disclosures whereof are incorporated by reference herein. A direct liquid fuel cell which is particularly suitable for use in combination with the solid mixture of the present invention is described in co-pending U.S. provisional application No. 61/071,903 entitled “Fuel Cell System and Method of Activating the Fuel Cell”, filed May 23, 2008, the entire disclosure whereof is expressly incorporated by reference herein.

One exemplary type of direct liquid fuel cells which will benefit from the solid fuels of the present invention are portable liquid fuel cells, e.g., fuel cells which can be used to power and/or charge (portable) electric or electronic devices such as (cellular) phones, (portable) computers, PDAs, consumer electronics, (portable) medical devices and components and peripherals thereof. Such portable fuel cells will usually be of a size that fits into a bag and will usually weigh (in the filled state) not more than about 50 kg, e.g., not more than about 25 kg, not more than about 10 kg, not more than about 5 kg, not more than about 2 kg, not more than about 1 kg, or not more than about 0.5 kg.

It is to be appreciated that the suitability of the solid fuel composition or body of the present invention is not limited to the preparation of a fuel for a direct liquid fuel cell. For example, the solid fuel composition or body may be used for any other purposes for which hydride compounds in general may be employed, for example, for generating hydrogen gas therefrom.

As set forth above, if a solid hydride-containing fuel for making a liquid fuel for a direct liquid fuel cell is to be provided there are several ways in which the at least one solid hydride compound may be provided to the fuel cell. In particular, the at least one solid hydride compound may be provided in combination with one or both of (i) at least one solid alkaline compound and (ii) an aqueous liquid which has at least one alkaline compound dissolved and/or suspended therein.

If at least one solid alkaline compound is present, the at least one hydride compound and the at least one solid alkaline compound may be present separated from each other and/or combined in a composition or body which comprises one or more solid hydride compounds and one or more solid alkaline compounds. If a composition or body is to be provided the hydride compound(s) and alkaline compound(s) may be present as a (preferably intimate) mixture (optionally in combination with water and/or a binder, etc.), and/or they may be physically separated from each other, for example, in the form of a tablet or other body which comprises at least two parts (e.g., layers), one part which comprises one or more hydride compounds (optionally in combination with water and/or a binder, etc.) and another part which comprises one or more alkaline compounds (optionally in combination with water and/or a binder, etc.).

Of course, it is also possible for the composition or body to comprise at least two parts which both comprise one or more hydride compounds and one or more alkaline compounds, but in different (weight and/or molar) ratios (optionally in combination with water and/or a binder, etc.).

If the one or more hydride compounds and the one or more alkaline compounds are to be provided in physically separated form they may be provided, for example, in the form of separate bodies (e.g., tablets, pellets, granules, flakes, combinations thereof, etc.), one type of body comprising the one or more hydride compounds (and substantially no alkaline compound(s)) and another type of body comprising the one or more alkaline compounds (and substantially no hydride compound(s)). Of course, it is also possible to provide at least two separate bodies which differ from each other in that they comprise the one or more hydride compounds and the one or more alkaline compounds in different (weight and/or molar) ratios. In this case, the hydride compound(s) and the alkaline compound(s) may be present in the form of an (intimate) mixture and/or physically separated from each other in the same body (e.g., in the form of layers). Finally, it is also possible, for example, to provide separate bodies of which one type comprises the one or more hydride compounds (and substantially no alkaline compound(s)) and at least one other type which comprises both hydride compound(s) and alkaline compound(s), optionally in combination with yet another type of body which comprises the one or more alkaline compounds (and substantially no hydride compound(s)).

If the solid fuel of the present invention comprises two or more hydride compounds these compounds can be present as physical mixture or physically separated from each other, or both. If the two or more hydride compounds are to be provided in physically separated form they can be present in the form of separate bodies (e.g., tablets, pellets, granules, flakes, combinations thereof, etc.) and/or they can be provided in the form of single body which comprises separate parts (e.g., separate layers). By way of non-limiting example, two different hydride compounds may be provided in the form of a multi-layered (e.g., bi-layered) tablet having at least one layer which comprises the first one of the two hydride compounds (or a mixture of the two hydride compounds which comprises a predominant amount of the first hydride compound), optionally in combination with one or more alkaline compounds, water, a binder, etc., and at least one other layer which comprises the second one of the two hydride compounds (or a mixture of the two hydride compounds which comprises a predominant amount of the second hydride compound), optionally in combination with one or more alkaline compounds, water, a binder, etc. Also, in the case of a three-layered tablet one layer comprising one of the two hydride compounds (or a predominant amount thereof) may be sandwiched between two layers which comprise the other one of the two hydride compounds (or a predominant amount thereof). Of course, a corresponding body (e.g., tablet) may also comprise one or more additional layers which comprise one or more alkaline compounds (and substantially no hydride compound(s)).

Another non-limiting example of a way of keeping two hydride compounds separate from each other in the same body is to provide a core which comprises the first hydride compound (or at least a predominant amount thereof), optionally in combination with one or more alkaline compounds, water, a binder, etc., and at least one shell or coating which surrounds the core at least partially (and preferably substantially completely) and comprises the second hydride compound (or at least a predominant amount thereof), optionally in combination with one or more alkaline compounds water, a binder, etc. In this case, the first hydride compound preferably has a lower solubility in the (aqueous) liquid than the second hydride compound. Also in this case an additional separate layer which comprises substantially only one or more alkaline compounds may be provided.

Yet another way of keeping two hydride compounds separate from each other is to provide a solid matrix which comprises dispersed therein particles of the two different hydride compounds. The matrix may by in the form of a tablet, pellet, granule, flake, etc. and may comprise, for example, one or more of the materials which are set forth above. A corresponding matrix can also be used to keep one or more hydride compounds separate from one or more alkaline compounds.

Of course, the ways of keeping one or more hydride compounds and one or more alkaline compounds separate from each other and the ways of keeping two or more hydride compounds separate from each other can be combined in any desired way. For example, it is possible to provide a first body which comprises a first hydride compound, a second body which comprises a second hydride compound, and a third body which comprises one or more alkaline compounds. These bodies may have the same or a different configuration (e.g., all three of them may be tablets, or two of them may be tablets and one of them may be a granule). It is also possible to combine two of these bodies in a single body (e.g. a bi-layered tablet) which comprises the first and second hydride compounds or the first or second hydride compound and the one or more alkaline compounds, or to combine all three bodies in a single body (e.g., a three-layered tablet).

It is to be appreciated that keeping the one or more hydride compounds and the one or more alkaline compounds (and/or two or more hydride compounds) physically separated from each other (either in the form of separate bodies or in the form of a body which comprises separate parts such as, e.g., layers) may in certain cases be advantageous. In particular, a problem frequently encountered with solid fuel bodies which comprise a mixture of one or more hydride compounds and one or more alkaline compounds and/or a mixture of two or more hydride compounds is a disintegration of the fuel body at the time of interaction with the (aqueous) liquid used for making the liquid fuel. The reason for this disintegration is the difference in the solubilities of the hydride compounds and the alkaline compounds. For example, the solubility of KOH in water is significantly higher than the solubility of borohydrides in water. Also, the solubility of KBH₄ in water is significantly higher than that of NaBH₄. A disintegration of the solid fuel body may result in intensive suspension and/or foam formation in the fuel chamber. A negative influence of this disintegration may be observed especially on porous elements of the fuel cell (or hydrogen generator) such as, e.g., gas blocking layers, anodes, gas evacuation devices, and valves.

### EXAMPLES

### Example 1 (Comparative)

A fuel paste of the following composition (in % by weight) was prepared:

| | |
|---|---|
| NaBH₄ | 5.8% |
| KBH₄ | 31.2% |
| KOH | 18.9% |
| Water | 44.1% |

A Type: nano Al, nano Al₂O₃ and related compounds.

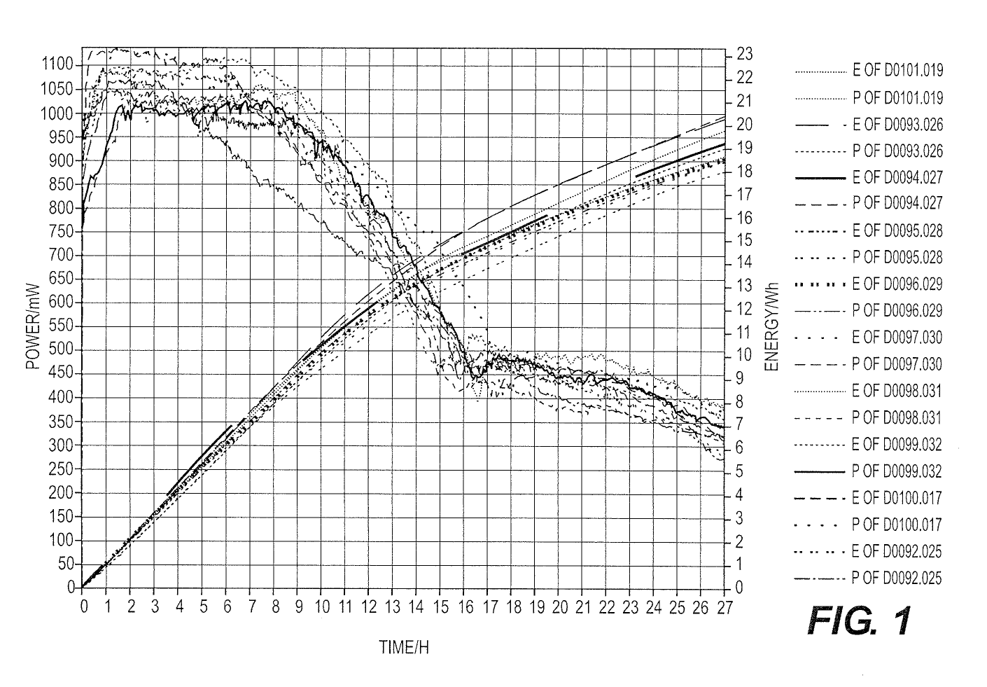

The above paste was combined with water at a weight ratio paste:water of 1:1.28 (i.e., 0.78) to produce a suspension and the discharge curves of the resultant fuel at a constant resistance of 0.33 ohm were recorded with several identical direct borohydride—air fuel cells (anode area=18 cm²; fuel volume 55 cc, electrolyte volume 4 cc) using a Maccor Series 4000/MC-4 battery tester. The discharge curves are shown in FIG. 1. The average discharge energy until the power fell below 0.4 watt was about 20.6 Wh.

### Example 2

### Tablet with Blended Components

A tablet of the following composition (in % by weight) and weighing was prepared:

| | |
|---|---|
| NaBH₄ | 10.0% |
| KBH₄ | 53.8% |
| KOH (90%)* | 36.2% |

*ground pellets containing 10% by weight of water, corresponding to 32.6% by weight of KOH and 3.6% by weight of water

The above components were blended in a rotary mixer at room temperature for about 30 minutes. A 22 g portion of the resultant intimate blend was placed into a tableting press and compressed at a pressure of about 100 kg/cm². The resultant tablet had a diameter of about 50 mm and was about 10 mm thick.

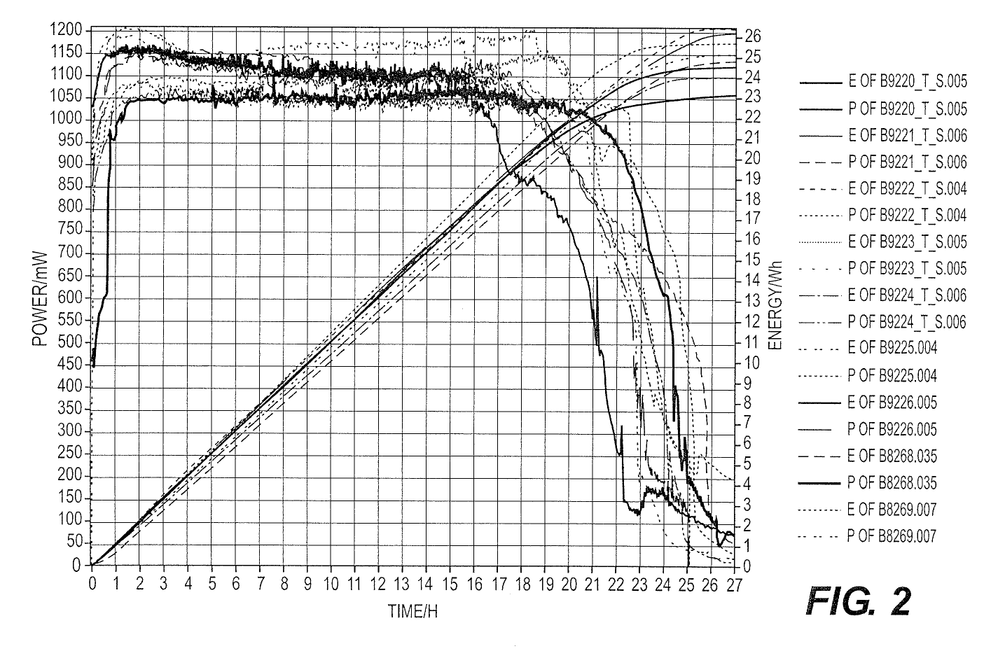

The tablet was combined with water at a weight ratio tablet:water of 1:1.82 (i.e., 0.55) (concentrations of solid components and water identical to those in Example 1) and the discharge curves of the resultant fuel were recorded at a constant resistance of 0.33 ohm with several identical direct borohydride—air fuel cells (anode area=18 cm²; fuel volume 55 cc, electrolyte volume 4 cc) using a Maccor Series 4000/MC-4 battery tester. The discharge curves are shown in FIG. 2. The average discharge energy until the power fell below 0.4 watt was about 24.6 Wh, which is an increase of about 20% compared to the fuel of Example 1.

### Example 3

### 3-Layer Tablet with Separated Components

The composition of the tablet is the same as that of Example 2:

| | |
|---|---|
| NaBH₄ | 10.0% |
| KBH₄ | 53.8% |
| KOH (90%) | 36.2% |

The components where employed to make tablets with the following three layers:

| | | |
|---|---|---|
| First layer - KBH₄ | 11.8 | g |
| Second layer - NaBH₄ | 2.2 | g |
| Third layer - KOH (90%) | 8.0 | g |
| Total Tablet weight - | 22 | g |
| Tablet diameter - | 50 | mm |
| Tableting pressure - | 100 | kg/cm² |

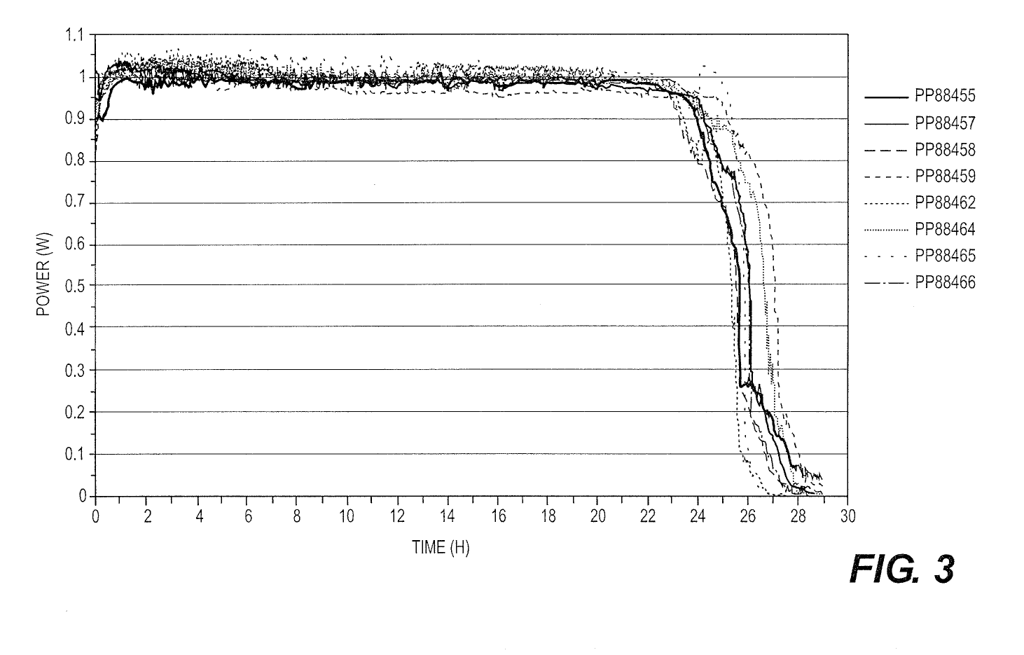

The above 3-layer tablet was combined with water at a weight ratio tablet:water of 1:1.82 (i.e., 0.55) (concentrations of solid components and water identical to those in Example 1 and 2) and the discharge curves of the resultant fuel were recorded at a constant resistance of 0.33 ohm with several identical direct borohydride—air fuel cells (anode area=18 cm²; fuel volume 55 cc, electrolyte volume 4 cc) using a Maccor Series 4000/MC-4 battery tester. The discharge curves are shown in FIG. 3. The average discharge energy until the power fell below 0.4 watt was about 26.8 Wh, which is an increase of about 30% compared to the fuel of Example 1.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A solid fuel composition, wherein the composition is suitable for preparing a liquid fuel for a direct liquid fuel cell and comprises, based on a total weight of the mixture, from about 10% to about 99.8% by weight of (i) at least one solid hydride compound selected from borohydrides, aluminum hydrides, and metal hydrides, and from about 0.1% to about 50% by weight (ii) of at least one alkaline compound selected from hydroxides of alkali and alkaline earth metals, Zn, Al, and ammonium, and wherein the composition, if placed in a direct liquid fuel cell and contacted with an aqueous liquid which is capable of dissolving the composition, dissolves gradually as the at least one hydride compound is consumed while the fuel cell is in operation.

2. The solid fuel composition of claim 1, wherein the composition provides at least one of a discharge energy and an operating power in the direct liquid fuel cell which is at least about 10% higher than at least one of a discharge energy and an operating power provided by a liquid fuel of the same composition under identical conditions.

3. The solid fuel composition of claim 1, wherein the composition comprises from about 20% to about 60% by weight of (i).

4. The solid fuel composition of claim 3, wherein (i) comprises one or more of LiBH₄, NaBH₄, KBH₄, NH₄BH₄, Be(BH₄)₂, Mg(BH₄)₂, Ca(BH₄)₂, Zn(BH₄)₂, Al(BH₄)₃, a polyborohydride, (CH₃)₂NHBH₃, NaCNBH₃, Li(AlH₄), LiH, NaH, KH, MgH₂, and CaH₂.

5. The solid fuel composition of claim 3, wherein the composition comprises from about 1% to about 20% by weight of (ii).

6. The solid fuel composition of claim 5, wherein (ii) comprises one or more of LiOH, NaOH, KOH, NH₄OH, Mg(OH)₂, Ca(OH)₂, Ba(OH)₂, Zn(OH)₂, and Al(OH)₃.

7. The solid fuel composition of claim 1, wherein (i) has an average particle size of from about 0.005 mm to about 3 mm.

8. The solid fuel composition of claim 1, wherein (ii) has an average particle size of from about 0.005 mm to about 3 mm.

9. The solid fuel composition of claim 1, wherein the composition further comprises up to about 20% by weight of water.

10. The solid fuel composition of claim 1, wherein the composition further comprises at least one binder.

11. The solid fuel composition of claim 1, wherein the composition is present as at least one of a tablet, a pellet, a flake and a granule.

12. The solid fuel composition of claim 1, wherein at least parts of (i) and (ii) are present as a physical mixture.

13. The solid fuel composition of claim 1, wherein at least parts of (i) and (ii) are present in physically separated form.

14. The solid fuel composition of claim 1, wherein the composition is obtainable by compacting a solid mixture comprising, based on a total weight of the mixture, from about 10% to about 99.8% by weight of (i) at least one hydride compound selected from borohydrides, aluminum hydrides, and metal hydrides, and from about 0.1% to about 50% by weight of (ii) at least one alkaline compound selected from hydroxides of alkali and alkaline earth metals, Zn, Al, and ammonium, (i) having an average particle size of from about 0.005 mm to about 3 mm and (ii) having an average particle size of from about 0.05 mm to about 10 mm.

15. The solid fuel composition of claim 14, wherein the mixture comprises from about 20% to about 60% by weight of (i) and from about 1% to about 20% by weight of (ii), (i) comprises one or more of LiBH₄, NaBH₄, KBH₄, NH₄BH₄, Be(BH₄)₂, Mg(BH₄)₂, Ca(BH₄)₂, Zn(BH₄)₂, Al(BH₄)₃, a polyborohydride, (CH₃)₂NHBH₃, NaCNBH₃, Li(AlH₄), LiH, NaH, KH, MgH₂, and CaH₂ and (ii) comprises one or more of LiOH, NaOH, KOH, NH₄OH, Mg(OH)₂, Ca(OH)₂, Ba(OH)₂, Zn(OH)₂, and Al(OH)₃.

16. The solid fuel composition of claim 15, wherein the mixture has been obtained by compression under a pressure of from about 50 kg/cm² to about 2,000 kg/cm².

17. A hydride-based direct liquid fuel cell, wherein the fuel cell comprises the solid fuel composition of claim 1.

18. A hydride-based direct liquid fuel cell, wherein at least one of a main body of the fuel cell and a part or device connected to or connectable therewith comprises at least one hydride compound selected from borohydrides, aluminum hydrides, and metal hydrides in solid form.

19. The fuel cell of claim 18, wherein the at least one hydride compound is present in combination with at least one of (a) at least one solid alkaline compound selected from hydroxides of alkali and alkaline earth metals, Zn, Al, and ammonium, and (b) an alkaline aqueous liquid which is capable of dissolving the at least one solid hydride compound.

20. The fuel cell of claim 18, wherein a fuel chamber of the fuel cell comprises at least a part of the at least one hydride compound.

21. The fuel cell of claim 18, wherein the fuel cell is portable.

22. A solid hydride-containing body, wherein the body is suitable for preparing a liquid fuel for a direct liquid fuel cell and comprises at least one solid hydride compound selected from borohydrides, aluminum hydrides, and metal hydrides and, if placed in a direct liquid fuel cell and contacted with an aqueous liquid which is capable of dissolving the body, dissolves gradually as the at least one hydride compound is consumed while the fuel cell is in operation.

23. The body of claim 22, wherein the body is obtainable by a process which comprises compacting a solid composition which comprises at least one solid hydride compound which is selected from borohydrides, aluminum hydrides, and metal hydrides and has an average particle size of from about 0.005 mm to about 3 mm.

24. The body of claim 22, wherein the body further comprises at least one solid alkaline compound selected from hydroxides of alkali and alkaline earth metals, Zn, Al, and ammonium.

25. The body of claim 24, wherein the body further comprises up to about 20% by weight of water.

26. The body of claim 22, wherein the body is present as at least one of a tablet, a pellet, a flake and a granule.

27. The body of claim 22, wherein the body comprises at least two parts.

28. The body of claim 22, wherein the body is present as a tablet.

29. The body of claim 28, wherein the tablet has at least two layers.

30. The body of claim 27, wherein at least one of the at least two parts comprises at least about 70% by weight of the at least one hydride compound, based on a total weight of the at least one part.

31. The body of claim 29, wherein at least one of the at least two layers comprises at least about 70% by weight of at least one alkaline compound, based on a total weight of the at least one layer.

32. The body of claim 22, wherein the body comprises at least a first layer which comprises at least about 70% by weight of at least one first hydride compound, based on a total weight of the first layer, and a second layer which comprises at least about 70% by weight of at least one second hydride compound which is different from the at least one first hydride compound, based on a total weight of the second layer.

33. The body of claim 22, wherein the body comprises a core and at least one layer which surrounds the core at least partially.

34. The body of claim 33, wherein the core comprises at least about 70% by weight of at least one first hydride compound, based on a total weight of the core, and the at least one layer comprises at least about 70% by weight of at least one second hydride compound which is different from the at least one first hydride compound, based on a total weight of the at least one layer.

35. The body of claim 34, wherein a solubility in water of the at least one second hydride compound is higher than a solubility in water of the at least one first hydride compound.

36. The body of claim 22, wherein the body comprises a water-soluble matrix which has particles of the at least one solid hydride compound dispersed therein.
